(19) United States
(12) Patent Application Publication
(10) Pub. No.: US 2018/0349830 A1
(43) Pub. Date: Dec. 6, 2018

(54) SYSTEM AND METHOD FOR MARKET IDENTIFICATION VIA APPLICANT WORK HISTORY DATA

(71) Applicant: Courtney Sparkman, Baton Rouge, LA (US)

(72) Inventor: Courtney Sparkman, Baton Rouge, LA (US)

(21) Appl. No.: 15/829,664

(22) Filed: Dec. 1, 2017

Related U.S. Application Data
(60) Provisional application No. 62/429,718, filed on Dec. 2, 2016.

(51) Int. Cl. G06Q 10/06; G06Q 10/10

(52) U.S. Cl. CPC G06Q 10/063112; G06Q 10/1053

(57) ABSTRACT

There are many companies that provide on-site services for different industries. The sites where these services are provided often have unique characteristics and parameters that are difficult to capture or ascertain prior to interaction with the person who requires the services. In a preferred embodiment of this invention, on-site characteristics are provided via job applicant data culling and are used to aggregate models of companies and sites that require on-site services. Additionally, algorithms are used to characterize the general characteristics of these sites so that a person or persons marketing their on-site services may evaluate purchasers for enhanced matching.

### CROSS REFERENCE TO RELATED APPLICATIONS

Not applicable

### REFERENCE TO GOVERNMENT FUNDING SOURCES

Not applicable.

### REFERENCE TO SEQUENCE LISTING

Not applicable.

### BACKGROUND

### Fields of the Invention

The disclosure as detailed herein is in the technical field of client server computer applications. More specifically, the present disclosure relates to the technical field of human resource management. Even more specifically, the present disclosure relates to the technical field of decision tree-based client customer matching.

### Description of Related Art

As do most businesses, security guard companies want to have customers. However, information is lacking as to the companies or persons who may require their on-site services. Commonly, one must pull out a phone book or search on the internet and individually contact a company to ask if they require security. Further, there is no incentive for anyone to collect data about companies that require these services. As such, there is no way of knowing who needs services, typically people must call by phone and there is no central repository of information that serves to identify companies that need on-site services.

Companies that require on-site security services may have a lot of particular requirements or qualifications of people that are employed at their site that need to be identified or captured. For example, they may need people to be armed or unarmed, have CPR training, have union membership, have TWIC federal certification, be defibrillation certified. In addition, they may require that a car must patrol multiple properties or only perform their services in response to an alarm event. Also, these businesses may be of several types, including: commercial, retail, residential, or industrial, which all may require different operating parameters. Further, the properties themselves may have particular characteristics that are different on a per site basis. For example, the employment may require a concierge type of guard, a one-property patrol guard, or may even include a command center. The property may require social skills to interact with tenants, for example, or be in a high-risk area or an area where valuables are stored. In addition, specific services can also be required at different temporal times. For example, some services may only be required for certain portions of the year or month, or for specific hours of work during the week. Thus, there is no way of knowing who needs these particular services and employees may need to be hired based on the particular demands of a company requiring on-site services. Employee training is expensive and time-consuming.

Other on-site service providers may include janitorial services that may require union membership, and be of the type: commercial, residential, retail, or industrial. Similarly, these services may have differing types of temporal requirements. Landscapers also provide on-site services for people, similarly, landscaping services are performed on-site and may have unique service characteristics that need to be determined. They may require installation or maintenance of plants, the property may have size constraints, different local ecosystems, or rare combinations of plants. Further, similar to the above mentioned on-site types, there can be different temporal specificity of work required.

What is needed is a mechanism to capture unique characteristics and parameters that are difficult to capture or ascertain prior to interaction with the person who requires the services. Further, algorithms used to characterize the general characteristics of these sites so that a person or persons marketing their on-site services may evaluate purchasers for enhanced matching, would greatly increase efficiency for both on site service providers and requesters of those services.

### GENERAL SUMMARY OF THE INVENTION

There are many companies that provide on-site services for different industries. The sites where these services are provided often have unique characteristics and parameters that are difficult to capture or ascertain prior to interaction with the person who requires the services. In a preferred embodiment of this invention, on-site characteristics are provided via job applicant data culling and are used to aggregate models of companies and sites that require on-site services. Additionally, algorithms are used to characterize the general characteristics of these sites so that a person or persons marketing their on-site services may evaluate purchasers for enhanced matching.

An embodiment of the instant invention allows one to determine the needs of a site prior to a conversation with owners or managers. Yet another embodiment of the invention allows one to grade the sites via a risk analysis of whether to approach the site manager to bid on the job. Yet another embodiment of the invention allows for employee success to match their skills relevant work environment.

Yet another embodiment of the invention allows for sites to have better matches for their particular needs and the scope of the work delivered. Yet another embodiment of the invention reduces premises liability by having better match to employees who may perform services required. Yet another embodiment of the invention allows for a better relationship and predictability between site manager and service company.

Yet another embodiment of the invention allows for a better relationship between the site manager and the tenants on a particular site. Yet another embodiment of the invention allows for a site service organizer to quickly identify one or more site managers who match their specific needs without doing cost prohibitive research. Yet another embodiment of the invention allows a site service organizer to generate a higher number of proposals to prospective site managers. An additional embodiment allows one to allow a site manager a higher number of proposals to evaluate for better service.

### DESCRIPTION OF FIGURES

FIG. 1 is a diagram view which shows an exemplary hardware architecture of a computing device used in an embodiment of the invention.

FIG. 2 is a diagram view which shows an exemplary logical architecture for a client device, according to an embodiment of the invention.

FIG. 3 is a diagram of an exemplary architectural arrangement of clients, servers, and external services, according to an embodiment of the invention.

FIG. 4 is a diagram view which shows an embodiment of a hardware architecture of a computing device used in various embodiments of the invention.

FIG. 5 is a diagram view which shows relationships of the RAMS, it's submodules and network connections to devices.

FIG. 6 is a diagram view which shows relationships of the business metadata object and it's sub objects.

FIG. 7 is a diagram view which shows relationships of the property metadata object and it's sub objects.

FIG. 8 is a diagram view which shows relationships of the site work verification metadata object and it's sub objects.

FIG. 9 is a diagram view which shows relationships of the site temporal metadata object and it's sub objects.

FIG. 10 is a diagram view which shows relationships of the site metadata object and it's sub objects.

FIG. 11 is a diagram view which shows relationships of the remote applicant processer and it's submodules.

FIG. 12 is a diagram view which shows relationships of the previous remote worker submitter and it's submodules.

FIG. 13 is a diagram view which shows overall use of the system.

FIG. 14 is a diagram view which shows applying for a position via the RAMS.

FIG. 15 is a diagram view which shows entering in data for a specific remote worker manager.

FIG. 16 is a diagram view which shows entering in data for a specific site.

FIG. 17 is a diagram view which shows aggregating, calculating and analyzing site metadata objects.

FIG. 18 is a diagram view which shows embodiments of calculated parameters from one or more site metadata objects.

FIG. 19 is a diagram view which shows embodiments of scores that can be calculated from site calculated params.

FIG. 20 is a diagram view which shows embodiments of an algorithm to determine the billing rate score.

FIG. 21 is a diagram view which shows embodiments of an algorithm to determine the chance of change score.

FIG. 22 is a diagram view which shows embodiments of an algorithm to determine the liability score.

FIG. 23 is a diagram view which shows embodiments of an algorithm to determine the procedure score.

### DETAILED DESCRIPTION OF THE INVENTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

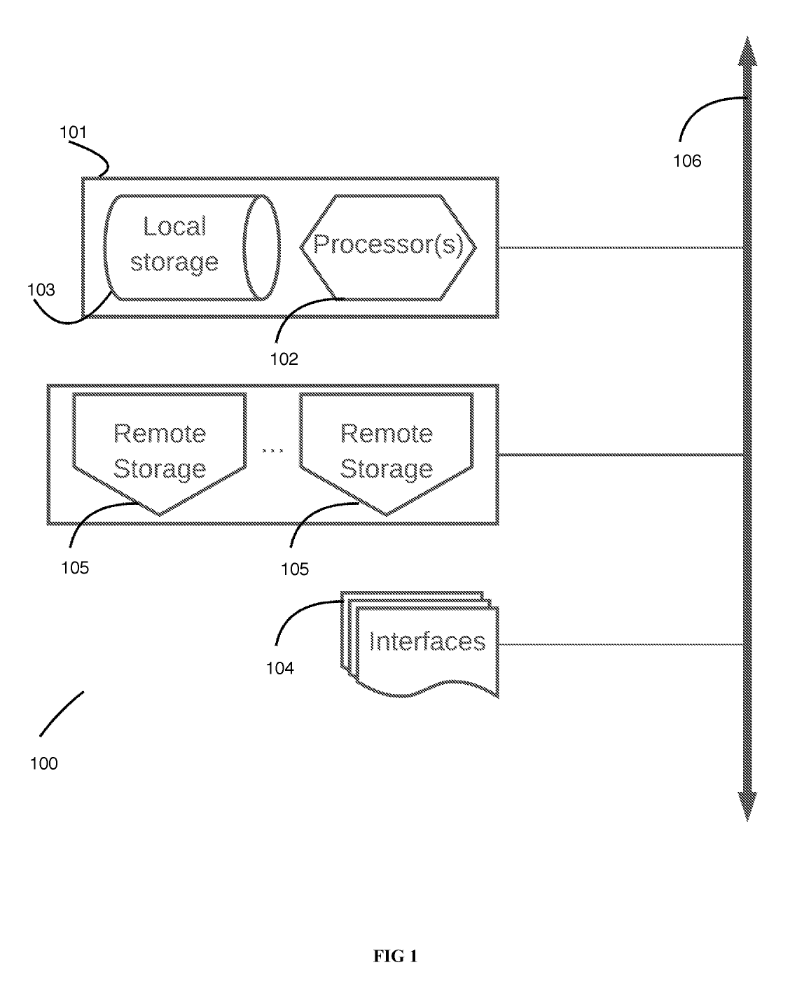

Referring now to FIG. 1, an exemplary hardware architecture of a computing device used in an embodiment of the invention. Computing device 100 (as in FIG. 1) comprises an electronic device capable of executing software- or hardware-based instructions according to one or more programs stored in memory. In some embodiments, examples of computing device 100 may include: desktop computers, carputers, game consoles, laptops, notebooks, a palmtop, a tablet, smartphones, smartbooks, or a server system utilizing CPU, local memory and/or remote memory, and interface(s). In some embodiments, computing device 100 serves to communicate with a plurality of other computing devices, such as clients or servers, over communications networks. Computing device 100 preferably comprises one or more CPU 101, one or more interface 104, one or more NIC, one or more busses, one or more memory 200, one or more non volatile memory 400, one or more storage devices 201, one or more input devices 202, one or more input output units 403, one or more operating systems 203, one or more output devices 204, one or more real time clock 404, and finally one or more power supply 405. CPU 101 (as in FIG. 1) comprises a unit responsible for implementing specific functions associated with the functions of a specifically configured computing device or machine. In some embodiments, examples of CPU 101 may include: a system-on-a-chip (SOC) type hardware, a Qualcomm SNAPDRAGON™, or a Samsung EXYNOS™ CPU. In some embodiments, CPU 101 serves to perform one or more of the different types of functions and/or operations under the control of software modules or components, which for example, may include an operating system and any appropriate applications software, drivers, and the like. In yet other embodiments, CPU 101 may also serve to run software that carry out one or more functions or applications of embodiments of the invention. Additionally, in other embodiments, CPU 101 serves to carry out computing instructions under control of an operating system. CPU 101 preferably comprises one or more processor 102 and one or more local memory 103. In some embodiments, examples of processor 102 may include: an Intel processor, an ARM processor, a Qualcomm processor, an AMD processor, application-specific integrated circuits (ASICs), electrically erasable programmable read-only memories (EEPROMs), field-programmable gate arrays (FPGAs), a mobile processor, a microprocessor, a microcontroller, a microcomputer, a programmable logic controller, or a programmable circuit.

Local memory 103 (as in FIG. 1) comprises one or more physical devices used to store programs (sequences of instructions) or data (e g. program state information) on a temporary or permanent basis for use in a computer or other digital electronic device, which may be configured to couple to the system in many different configurations. In some embodiments, examples of local memory 103 may include: non-volatile random access memory (RAM), read-only memory (ROM), or a one or more levels of cached memory. In some embodiments, local memory 103 serves to cache and/or store data. In other embodiments, local memory 103 may also serve to store programming instructions. Interface 104 (as in FIG. 1) comprises a mechanism to control the sending and receiving of data packets over a computer network or support peripherals used with computing device 100. In some embodiments, examples of interface 104 may include: network interface cards (NICs), ethernet interfaces, frame relay interfaces, cable interfaces, DSL interfaces, token ring interfaces, graphics interfaces, universal serial bus (USB) interfaces, Serial port interfaces, Ethernet interfaces, FIREWIRE™ interfaces, THUNDERBOLT™ interfaces, PCI interfaces, parallel interfaces, radio frequency (RF) interfaces, BLUETOOTH™ interfaces, near-field communications interfaces, 802.11 (WiFi) interfaces, frame relay interfaces, TCP/IP interfaces, ISDN interfaces, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, or fiber data distributed interfaces (FDDIs). Interface 104 preferably comprises one or more physical ports, one or more independent processor, and finally one or more interface memory. Communications network 106 (as in FIG. 1) comprises a communications network that allows computers to exchange data using known protocols. In some embodiments, examples of communications network 106 may include: a personal area network, a wireless personal area network, a near-me area network, a local area network, a wireless local area network, a wireless mesh network, a wireless metropolitan area network, a wireless wide area network, a cellular network, a home area network, a storage area network, a campus area network, a backbone area network, a metropolitan area network, a wide area network, an enterprise private network, a virtual private network, an intranet, an extranet, an Internetwork, an Internet, near field communications, a mobile telephone network, a CDMa network, GSM cellular networks, or a WiFi network. Remote memory 105 (as in FIG. 1) comprises a service that provides users with a system for the backup, storage, and recovery of data.

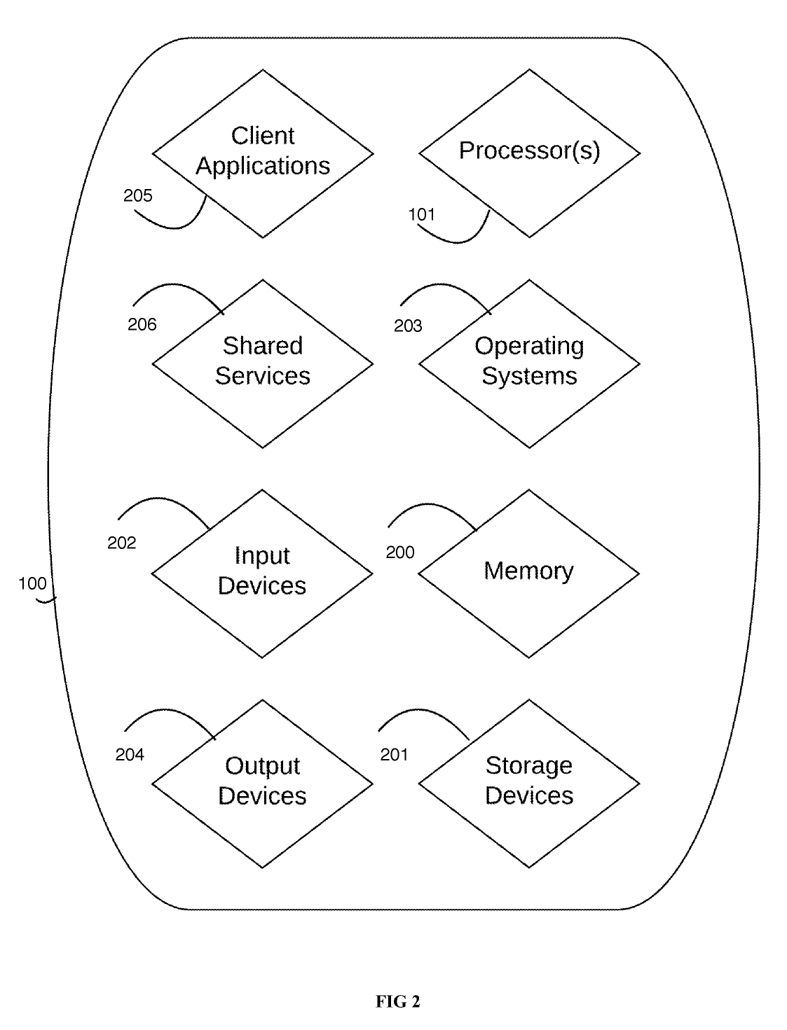

Referring now to FIG. 2, which shows an exemplary logical architecture for a client device, according to an embodiment of the invention. Memory 200 (as in FIG. 2) comprises mechanism designed to store program instructions, state information, and the like for performing various operations described herein, may be storage devices 201, in some embodiments. In some embodiments, examples of memory 200 may include: read-only memory (ROM), read-only memory devices (ROM), a memristor memory, random access memory (RAM), or RAM hardware modules. In some embodiments, memory 200 serves to cache and/or store data. In yet other embodiments, memory 200 may also serve to store program instructions. In yet other embodiments, memory 200 may also serve to store program instructions for the general-purpose network operations. In yet other embodiments, memory 200 may also serve to store information relating to the functionality of the system. In yet other embodiments, memory 200 may also serve to store data structures. In yet other embodiments, memory 200 may also serve to store configuration data. In yet other embodiments, memory 200 may also serve to store encryption data. In yet other embodiments, memory 200 may also serve to store historical system operations information. Additionally, in other embodiments, memory 200 serves to store generic non-program information. Operating systems 203 (as in FIG. 2) comprises system software that manages computer hardware and software resources and provides common services for computer programs. In some embodiments, examples of operating systems 203 may include: a Microsoft's WINDOWS™, an Apple's Mac OS/X, iOS operating systems, a Linux operating system, or a Google's ANDROID™ operating system. Input devices 202 (as in FIG. 2) comprises device of any type suitable for receiving user input. Input devices 202 preferably comprises one or more keyboard 401, one or more touchscreen, one or more microphone, mouse 402, a touchpad, and finally a trackball.

Output devices 204 (as in FIG. 2) comprises device of any type suitable for outputting computing device 100 related information. In some embodiments, examples of output devices 204 may include: a screens for visual output, speakers, or printers. Storage devices 201 (as in FIG. 2) comprises mechanism designed to store information which in some embodiments may be memory 200. In some embodiments, examples of storage devices 201 may include: magnetic media, hard disks, floppy disks, a magnetic tape, optical media, CD-ROM disks, magneto-optical media, optical disks, a flash memory, solid state drives (SSD), “hybrid SSD” storage drives, swappable flash memory modules, thumb drives, hot-swappable hard disk drives, solid state drives, removable optical storage discs, or an electrical storage device. Shared services 206 (as in FIG. 2) comprises web-enabled services or functionality related to computing device 100.

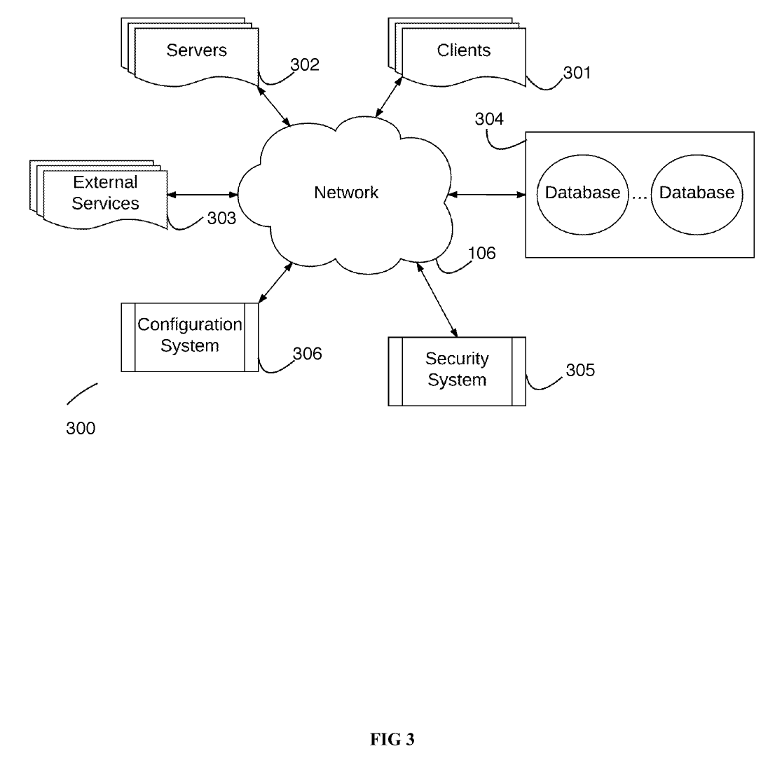

Referring now to FIG. 3, which shows Client 301 (as in FIG. 3) comprises one or more computing device 100 with program instructions for implementing client-side portions of the present system which in some embodiments, may be connected to communications network 106. Server 302 (as in FIG. 3) comprises computing device 100 configured to handle requests received from one or more client 301 over communications network 106. In some embodiments, server 302 serves to call one or more external services 303 when needed to obtain additional information, or to refer to additional data concerning a particular call. External service 303 (as in FIG. 3) comprises web-enabled services or functionality related to or installed on computing device 100 itself which may be deployed on one or more of a particular enterprise's or user's premises.

Security system 305 (as in FIG. 3) comprises a system common to information technology (IT) and web functions that implements security related functions for the system. Configuration system 306 (as in FIG. 3) comprises a system common to information technology (IT) and web functions that implements configurations or management system. Database 304 (as in FIG. 3) comprises an organized collection of data within a programs instruction related system, designed to allow the definition, creation, querying, update, and administration of databases. In some embodiments, examples of database 304 may include: a relational database system, a NoSQL system, a Hadoop system, a Cassandra system, a Google BigTable, column-oriented databases, in-memory databases, or clustered databases. Distributed computing network 300 (as in FIG. 3) comprises any number of client 301 and/or server 302 operably connected to communications network 106 for the purposes of implementing the system. Distributed computing network 300 preferably comprises one or more client application 205, one or more client 301, one or more server 302, one or more external service 303, one or more shared services 206, one or more database 304, one or more security system 305, and finally configuration system 306.

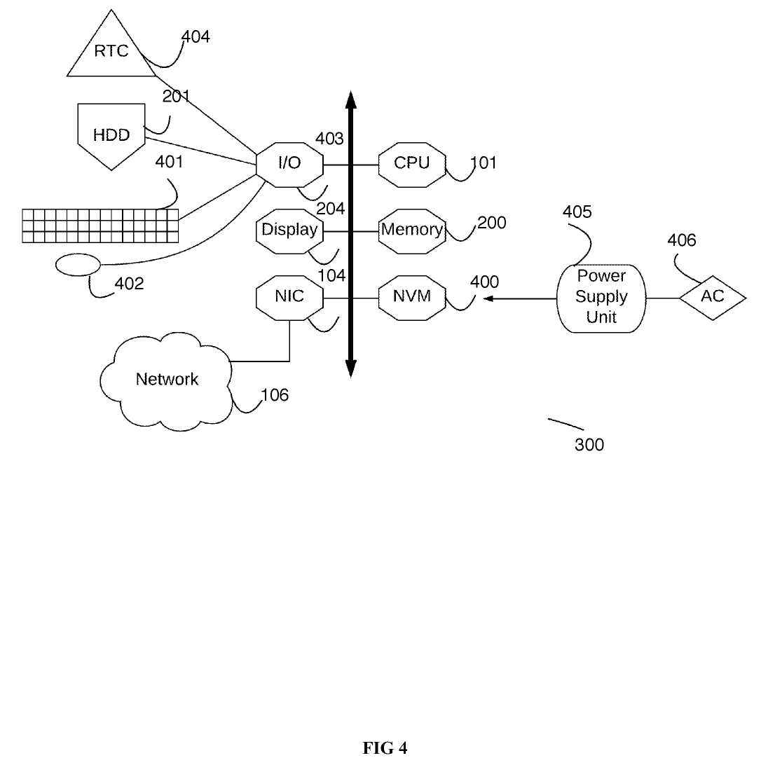

Referring now to FIG. 4, which shows an embodiment of a hardware architecture of a computing device used in various embodiments of the invention. Non volatile memory 400 (as in FIG. 4) comprises computer memory 200 that can retrieve stored information even after having been power cycled (turned off and back on). Real time clock 404 (as in FIG. 4) comprises a computer device clock (most often in the form of an integrated circuit) that keeps track of the current time. Input output units 403 (as in FIG. 4) comprises devices used by a human (or other system) to communicate with a computer.

Power supply 405 (as in FIG. 4) comprises an electronic device that supplies electric energy to an electrical load. Power supply 405 preferably comprises one or more power source 406. In some embodiments, an example of power source 406 could be an AC power or a DC power and the like.

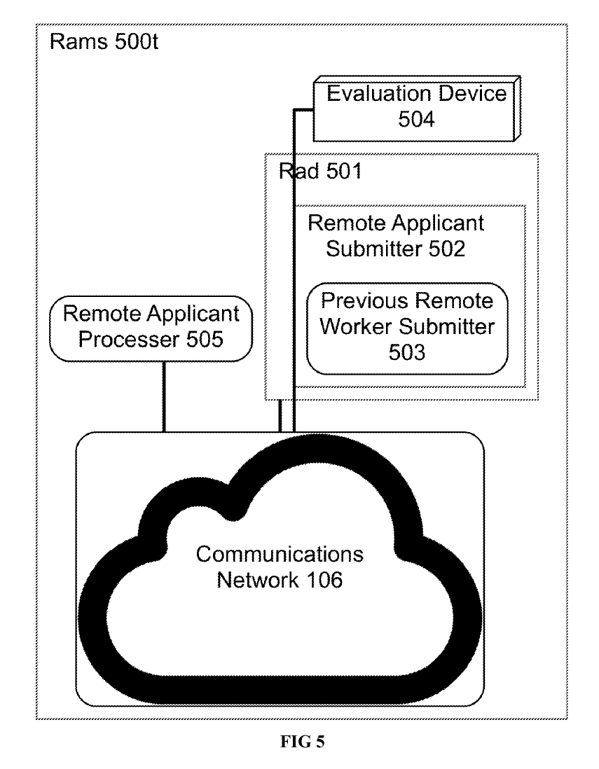

Referring now to FIG. 5, which shows relationships of the RAMS, it's submodules and network connections to devices. RAMS 500 (as in FIG. 5) comprises a system that accepts remote worker site history concomitant with the job history during the application process and derives one or more calculated parameters from the site data. The (RAMS 500) is an acronym which stands for ‘remote applicant system’. Rams 500 preferably comprises RAD 501, evaluation device 504, and finally remote applicant processor 505. RAD 501 (as in FIG. 5) comprises computing device 100 used by a remote worker. The (RAD 501) is an acronym which stands for ‘remote applicant device’. Rad 501 preferably comprises remote applicant submitter 502. Evaluation device 504 (as in FIG. 5) comprises computing device 100 that displays one or more site calculated parameters 1103 or evaluation scores 1105.

Remote applicant processor 505 (as in FIG. 5) comprises computing device 100 that receives site data from one or more remote worker for analyzing and processing. Remote applicant processor 505 preferably comprises site metadata aggregator 1100, a remote worker manager configurator, site calculator 1102, site calculated parameters 1103, site evaluator 1104, evaluation scores 1105, and finally site metadata object 1000. Remote applicant submitter 502 (as in FIG. 5) comprises the user interface on RAD 501 that is used to gather remote worker data when applying for a job with a remote worker manager. Remote applicant submitter 502 preferably comprises previous remote worker submitter 503. Previous remote worker submitter 503 (as in FIG. 5) comprises the form on a graphical user interface which inputs information about a particular previous remote worker manager e.g. employer. Previous remote worker submitter 503 preferably comprises site metadata submitter 1200.

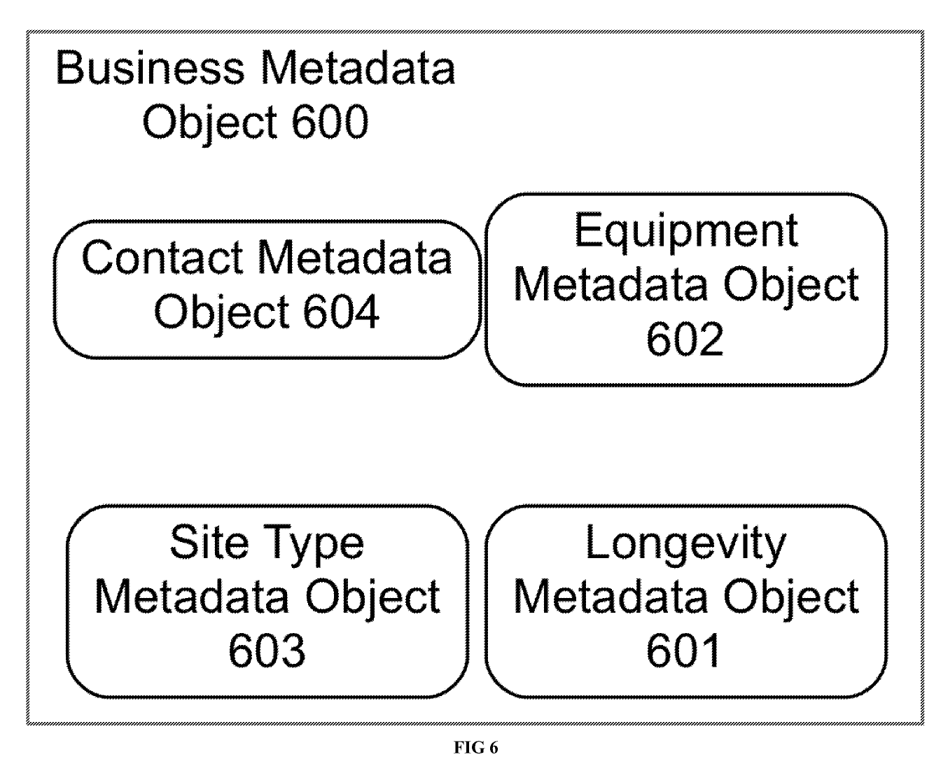

Referring now to FIG. 6, which shows relationships of the business metadata object and its sub objects. Business metadata object 600 (as in FIG. 6) comprises the stored data or information which identifies the business related factors that needs a remote worker service. Business metadata object 600 preferably comprises longevity metadata object 601, equipment metadata object 602, site type metadata object 603, and finally contact metadata object 604. Longevity metadata object 601 (as in FIG. 6) comprises the stored data which indicates how long a specific site has used a specific remote worker manager. Equipment metadata object 602 (as in FIG. 6) comprises the information regarding whether a specific site utilizes or requires specific items for use by the remote worker. In some embodiments, it is thought that an example of equipment metadata object 602 could be car data or perhaps personal autonomous vehicle data and the like.

Site type metadata object 603 (as in FIG. 6) comprises the stored data object that indicates the classification of a particular site. In some embodiments, it is thought that examples of site type metadata object 603 may include: commercial type data, retail type data, residential type data, industrial type data, or event type data. Contact metadata object 604 (as in FIG. 6) comprises the information about how to contact the site manager and/or the site service organizer.

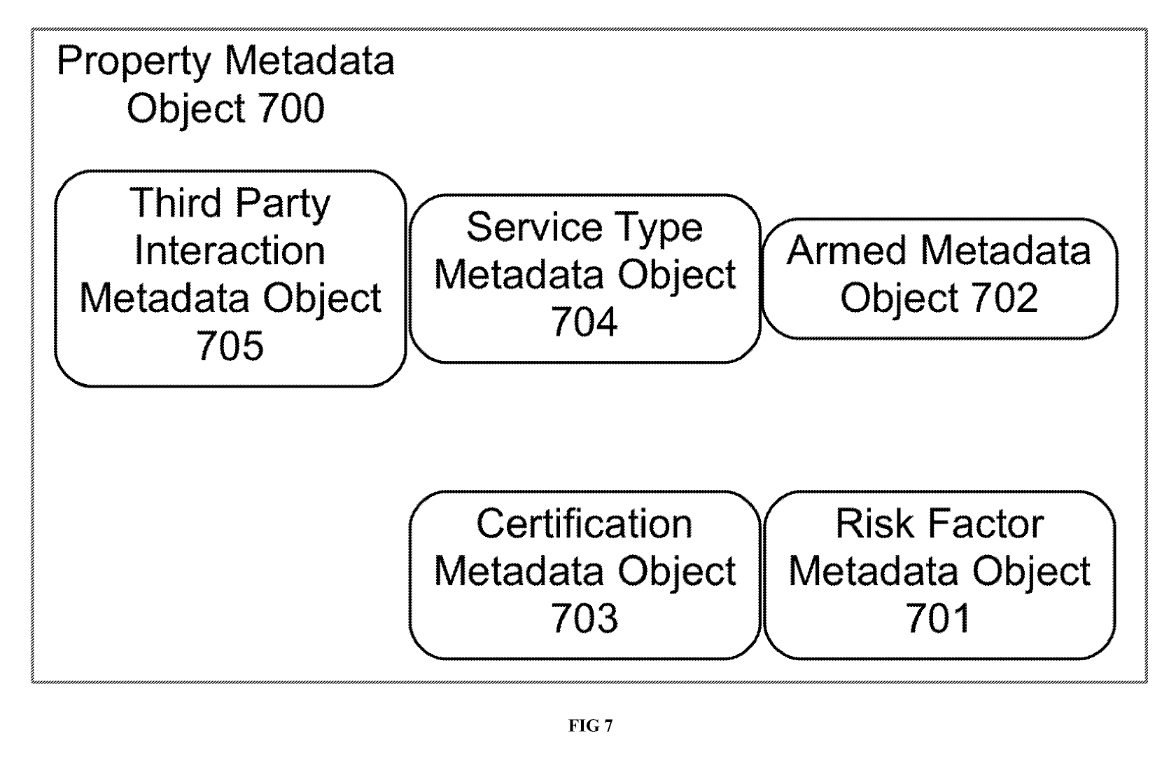

Referring now to FIG. 7, which shows relationships of the property metadata object and it's sub objects. Property metadata object 700 (as in FIG. 7) comprises the stored data object which identifies the property requirements needed by one or more remote workers who perform a service on the site. Property metadata object 700 preferably comprises risk factor metadata object 701, armed metadata object 702, certification metadata object 703, service type metadata object 704, and finally third party interaction metadata object 705. Risk factor metadata object 701 (as in FIG. 7) comprises the stored data object which indicates the security risk present at a particular site. In some embodiments, it is thought that examples of risk factor metadata object 701 may include: high risk area data, containing valuables, previous police intervention data, issuance of detainment equipment data, or issuance of defensive tools data. Armed metadata object 702 (as in FIG. 7) comprises the stored data object which indicates whether the remote worker is armed while performing services on the site. In some embodiments, it is thought that an example of armed metadata object 702 could be commissioned (carries a firearm) data or perhaps non commissioned (does not carry a firearm) data and the like.

Certification metadata object 703 (as in FIG. 7) comprises the stored data object which indicates one or more relevant certifications that may have been required for a site. In some embodiments, it is thought that examples of certification metadata object 703 may include: CPR certification data, union membership data, AED defib certification data, or TWIC certification data. Third party interaction metadata object 705 (as in FIG. 7) comprises the stored data object which indicates the third parties with which the remote worker must interact with on a regular basis at a particular site. In some embodiments, it is thought that examples of third party interaction metadata object 705 may include: tenants data, general public data, other contractors data, employees data, or customers data.

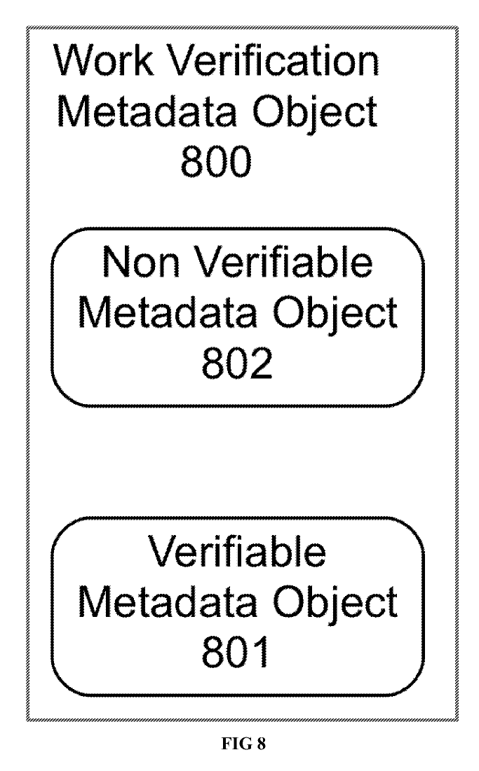

Referring now to FIG. 8, which shows relationships of the site work verification metadata object and it's sub objects. Work verification metadata object 800 (as in FIG. 8) comprises the stored data object which indicates the types of reporting that is required to validate that a remote worker performed the service requested at a particular site. Work verification metadata object 800 preferably comprises verifiable metadata object 801 and non verifiable metadata object 802. Verifiable metadata object 801 (as in FIG. 8) comprises the stored data object that indicates the type of verifiable reporting system that is used. In some embodiments, it is thought that examples of verifiable metadata object 801 may include: realtime reporting data, position based QR codes data, GPS tracking data, RFID data, NFC data, bluetooth data, or short range wireless interconnect data. Non verifiable metadata object 802 (as in FIG. 8) comprises the stored data object that indicates the type of non verifiable reporting system that is used. For example, a summary of what has happened (also called analog report) vs. any real time verification. In some embodiments, it is thought that an example of non verifiable metadata object 802 could be paper reports data or perhaps electronic reports data and the like.

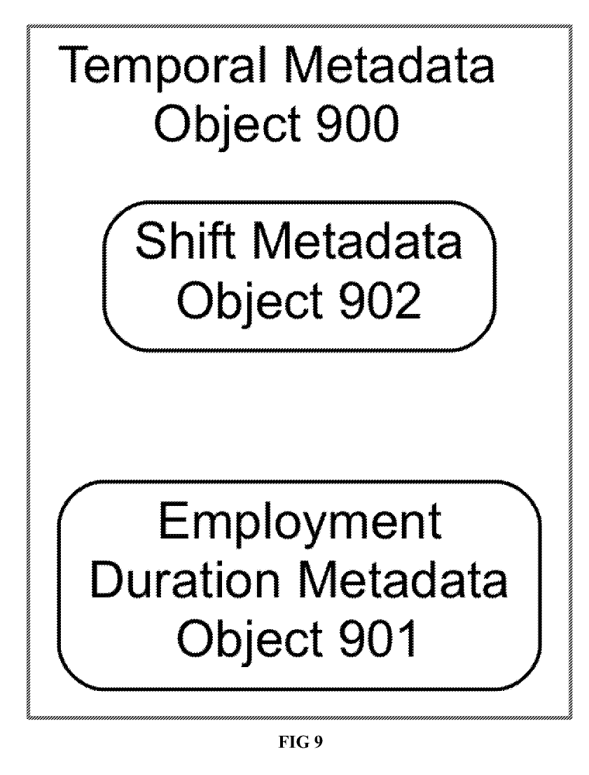

Referring now to FIG. 9, which shows relationships of the site temporal metadata object and it's sub objects. Temporal metadata object 900 (as in FIG. 9) comprises the stored data object which indicates the temporal requirements of a remote worker when performing the service requested at a particular site. Temporal metadata object 900 preferably comprises employment duration metadata object 901 and shift metadata object 902. Employment duration metadata object 901 (as in FIG. 9) comprises the stored data which indicates the length of employment of a remote worker at a specific site. Shift metadata object 902 (as in FIG. 9) comprises the stored data which indicates the first, second, third, weeks/weekends of a remote worker at the site.

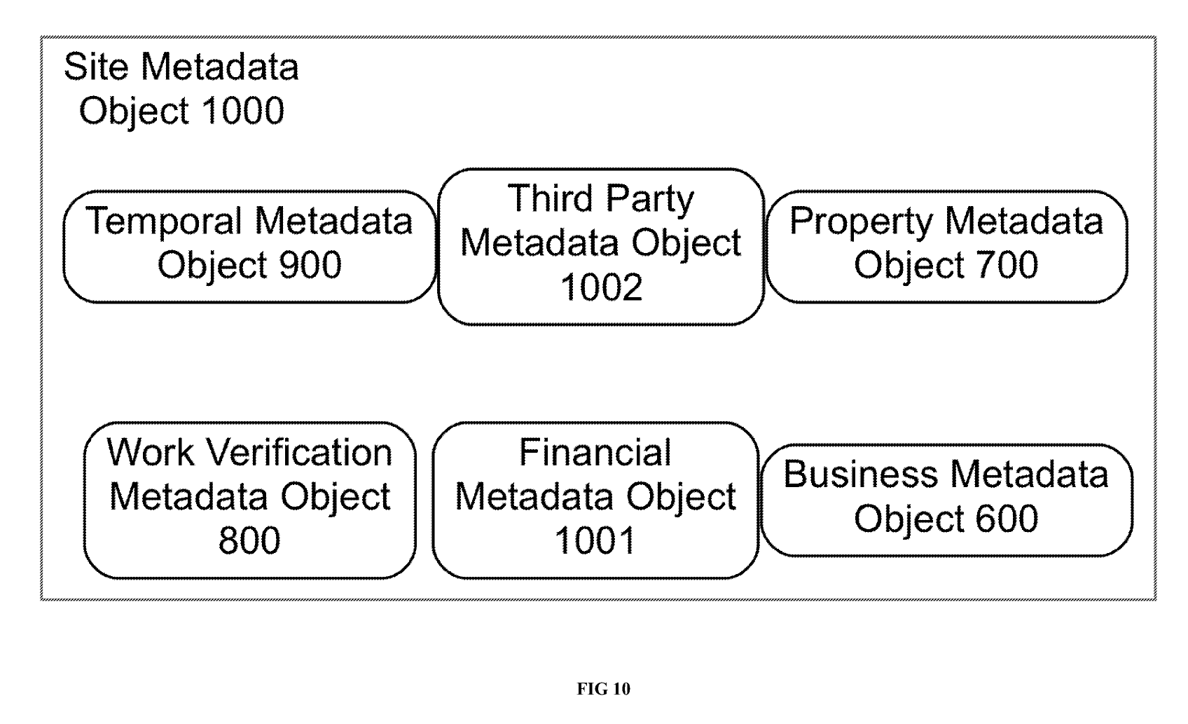

Referring now to FIG. 10, which shows relationships of the site metadata object and it's sub objects. Financial metadata object 1001 (as in FIG. 10) comprises the stored data object which indicates the cost of a remote worker to provide service at a particular site. In some embodiments, it is thought that examples of financial metadata object 1001 may include: pay rates data, vacation time data, sick time data, 401k data, or health benefits data. Third party metadata object 1002 (as in FIG. 10) comprises the stored object which contains information about a site that is obtained from publicly available and/or third party sources. In some embodiments, it is thought that an example of third party metadata object 1002 may include crime data and the like. Site metadata object 1000 (as in FIG. 10) comprises the stored data object which contains information about a particular site. Site metadata object 1000 preferably comprises business metadata object 600, property metadata object 700, financial metadata object 1001, third party metadata object 1002, work verification metadata object 800, and finally temporal metadata object 900.

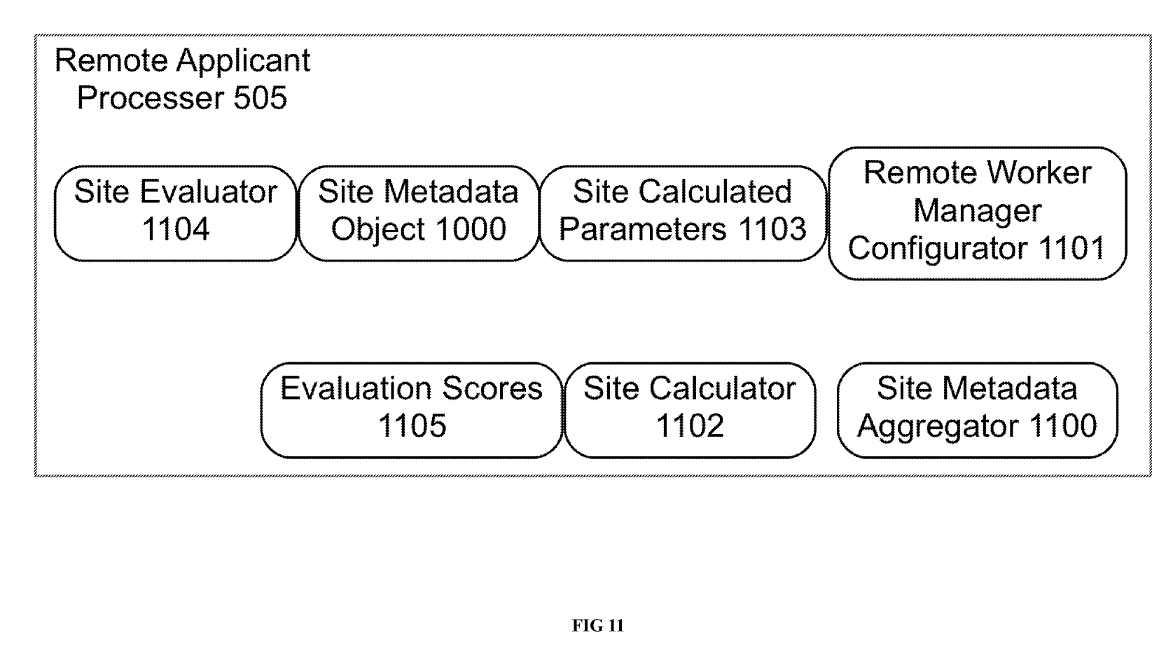

Referring now to FIG. 11, which shows relationships of the remote applicant processor and it's submodules. Site metadata aggregator 1100 (as in FIG. 11) comprises a module that aggregates one or more site metadata object 1000 and configures them to relate to a remote worker manager. Remote worker manager configurator 1101 (as in FIG. 11) comprises a module that aggregates one or more site metadata object 1000 previously configured to a remote worker manager and configures them to relate to a remote worker. Site calculator 1102 (as in FIG. 11) comprises a module that calculates site calculated parameters 1103 for algorithm analysis and reporting.

Site calculated parameters 1103 (as in FIG. 11) comprises one or more data objects containing calculated data parameters derived from equations related to site metadata object input. Evaluation scores 1105 (as in FIG. 11) comprises one or more data objects containing reporting scores derived from algorithms that used site metadata object 1000 parameters, and/or site calculated parameters 1103, and/or algorithm specific data inherent and/or third party data. Site evaluator 1104 (as in FIG. 11) comprises a module that implements algorithms based on input form site metadata object 1000 parameters, and/or site calculated parameters 1103, and/or algorithm specific data inherent and/or third party data.

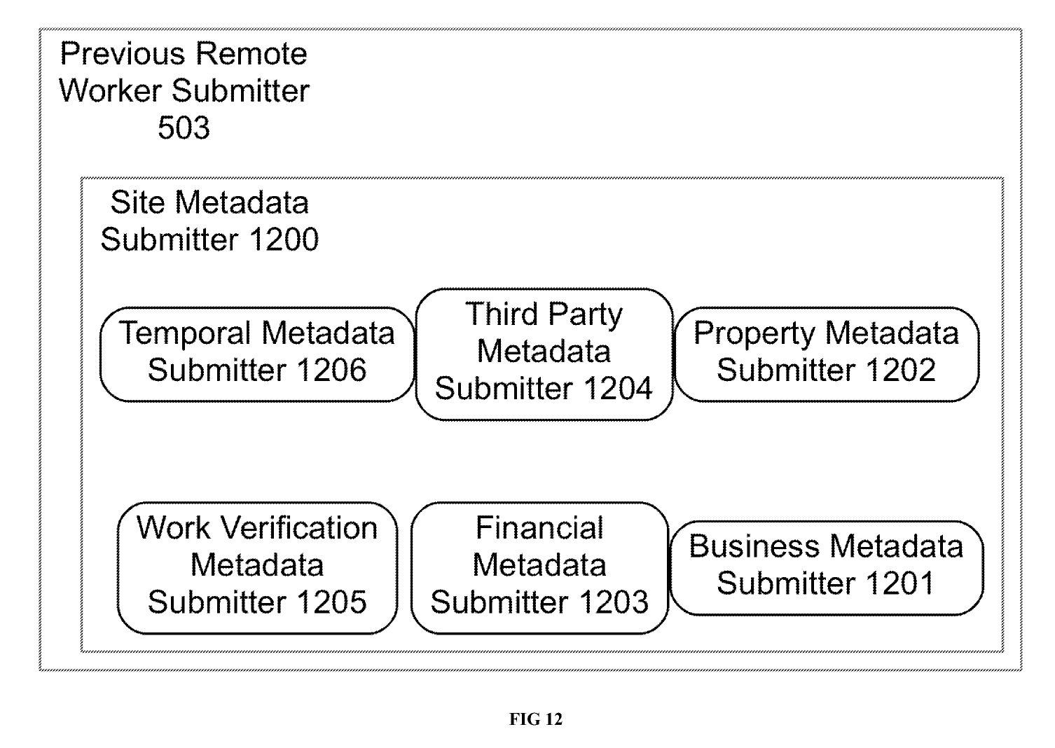

Referring now to FIG. 12, which shows relationships of the previous remote worker submitter and it's submodules. Site metadata submitter 1200 (as in FIG. 12) comprises the form on a graphical user interface which inputs information about a particular site where the remote worker had previously performed services at. Site metadata submitter 1200 preferably comprises business metadata submitter 1201, property metadata submitter 1202, financial metadata submitter 1203, third party metadata submitter 1204, work verification metadata submitter 1205, and finally temporal metadata submitter 1206. Business metadata submitter 1201 (as in FIG. 12) comprises the form on a graphical user interface which inputs the business related factors that needs a remote worker service and instantiates business metadata object 600. Property metadata submitter 1202 (as in FIG. 12) comprises the form on a graphical user interface which inputs the requirements needed by one or more remote worker who perform a service on the site and instantiates property metadata object 700.

Financial metadata submitter 1203 (as in FIG. 12) comprises the form on a graphical user interface which inputs the cost of a remote worker to provide service at a particular site and instantiates financial metadata object 1001. Third party metadata submitter 1204 (as in FIG. 12) comprises the form on a graphical user interface which inputs information about a site that is obtained from publicly available and/or third party sources and instantiates third party metadata object 1002. Third party metadata submitter 1204 has an alternative embodiment herein termed the ‘clarification’ embodiment. Work verification metadata submitter 1205 (as in FIG. 12) comprises the form on a graphical user interface which indicates the types of reporting that is required to validate that a remote worker performed the service requested at a particular site and instantiates work verification metadata object 800. Temporal metadata submitter 1206 (as in FIG. 12) comprises the form on a graphical user interface which inputs the temporal requirements of a remote worker when performing the service requested at a particular site and instantiates temporal metadata object 900.

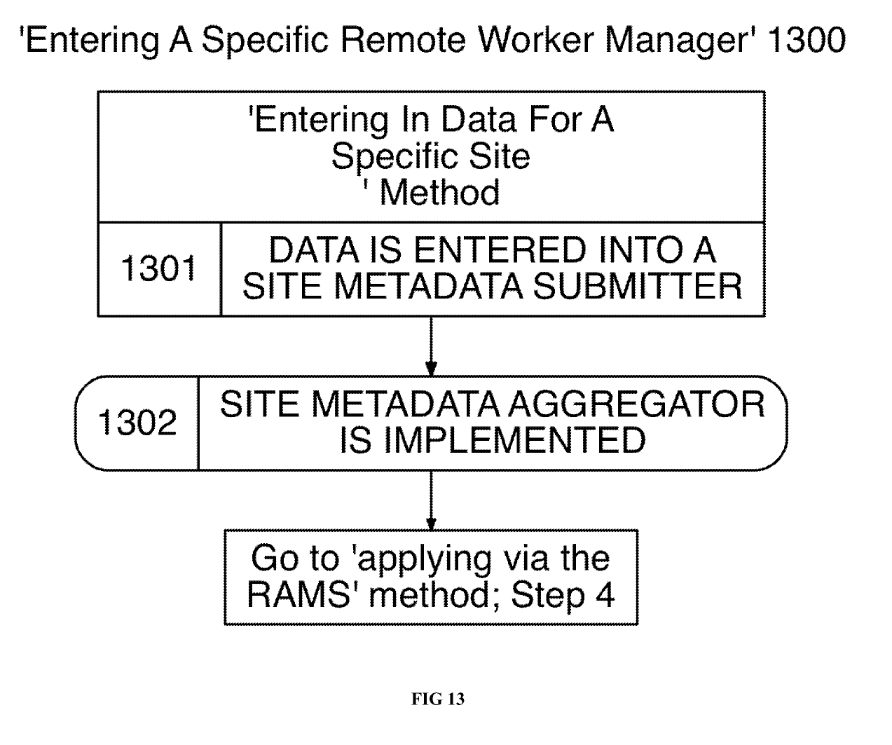

Referring now to FIG. 13, overall, a preferred embodiment of the invention is used as follows: First, a remote worker applies to one or more remote worker manager via a RAMS 500 and the input of which results in one or more site metadata object 1000 (Step 1301). This is further detailed below in (Step 1401-Step 1404).

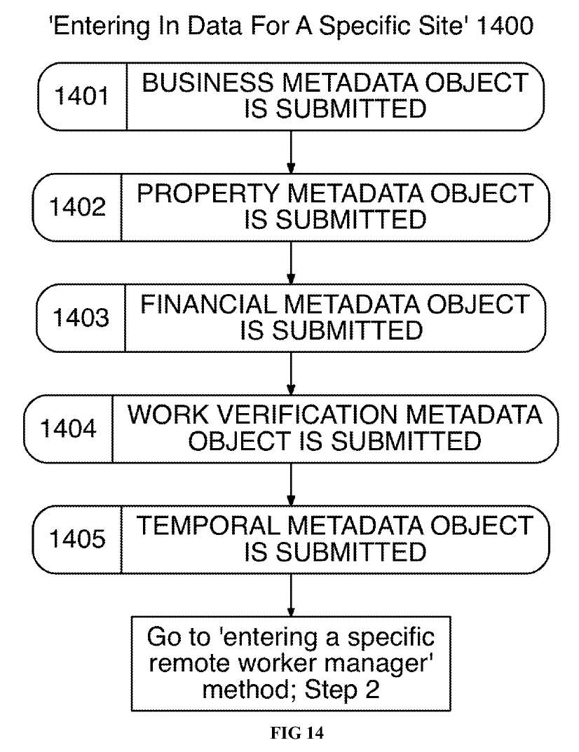

Now referring to FIG. 14, first, a remote worker interacts with a remote applicant interface 104 on RAD 501 (Step 1401). Next, a remote worker submits general employment information data on remote applicant submitter 502 (Step 1402). Next, a remote worker inputs data into previous remote worker submitter 503 for each previous remote worker manager, then for each remote worker manager the remote worker identifies one or more site and submits data for each therein (Step 1403). This is further detailed below in (Step 1501-Step 1502).

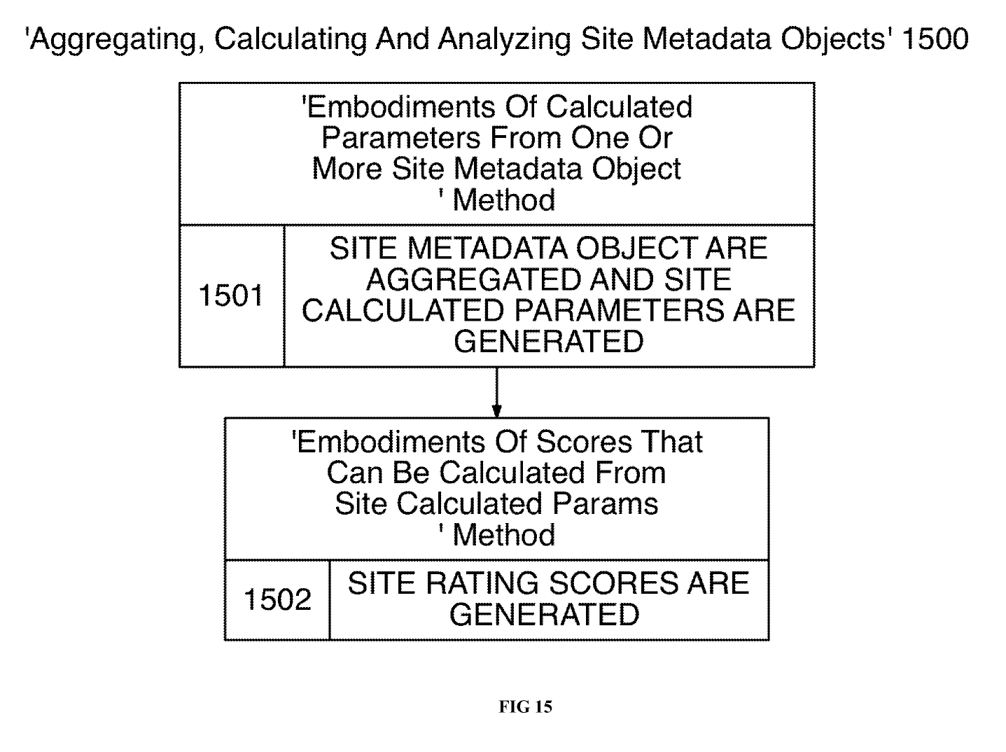

Now referring to FIG. 15, next, for each site for a remote worker manager data is entered into site metadata submitter 1200 (Step 1501). This is further detailed below in (Step 1601-Step 1605).

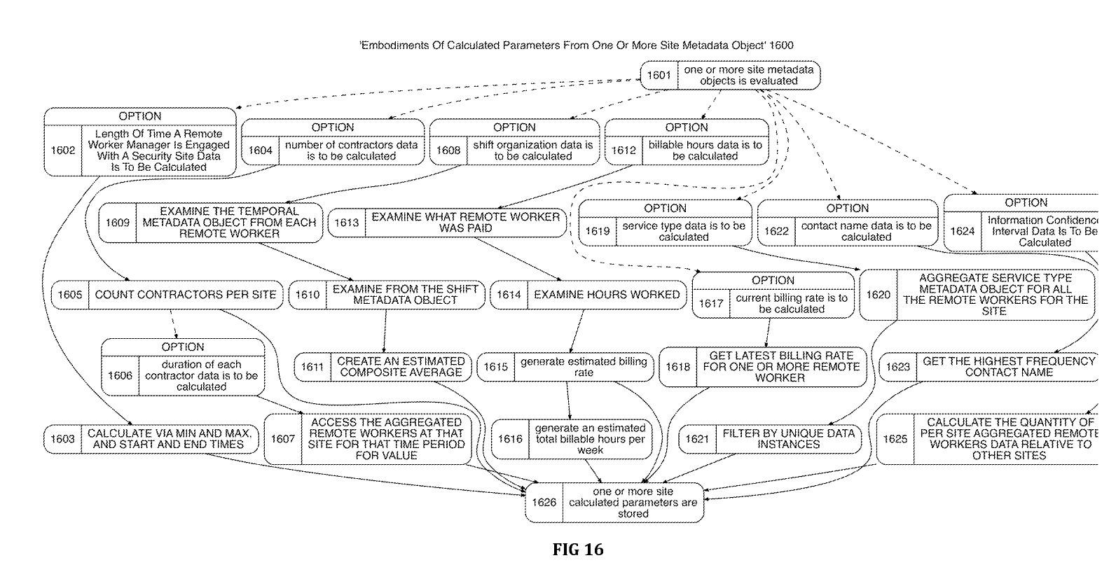

Now referring to FIG. 16, next, business metadata object 600 is submitted from RAD 501 via business metadata submitter 1201 and received at a remote applicant processor 102 (Step 1601). Next, property metadata object 700 is submitted from RAD 501 via property metadata submitter 1202 and received at a remote applicant processor 102 (Step 1602). Next, financial metadata object 1001 is submitted from RAD 501 via financial metadata submitter 1203 and received at a remote applicant processor 102 (Step 1603). Next, work verification metadata object 800 is submitted from RAD 501 via work verification metadata submitter 1205 and received at a remote applicant processor 102 (Step 1604). Next, temporal metadata object 900 is submitted from RAD 501 via temporal metadata submitter 1206 and received at a remote applicant processor 102 (Step 1605).

Referring back to FIG. 15, next, site metadata is aggregated from input at the remote applicant processor 102 by site metadata aggregator 1100 and configured to relate to that specific remote worker manager (Step 1502).

Referring back to FIG. 14, next, for each specific remote worker manager they are configured to operably relate to a remote worker via remote worker manager configurator 1101 (Step 1404).

Referring back to FIG. 13, next, for one or more remote worker, one or more site metadata object 1000 are aggregated for calculated parameters and then site rating scores are generated by one or more algorithms (Step 1302). This is further detailed below in (Step 1701-Step 1702).

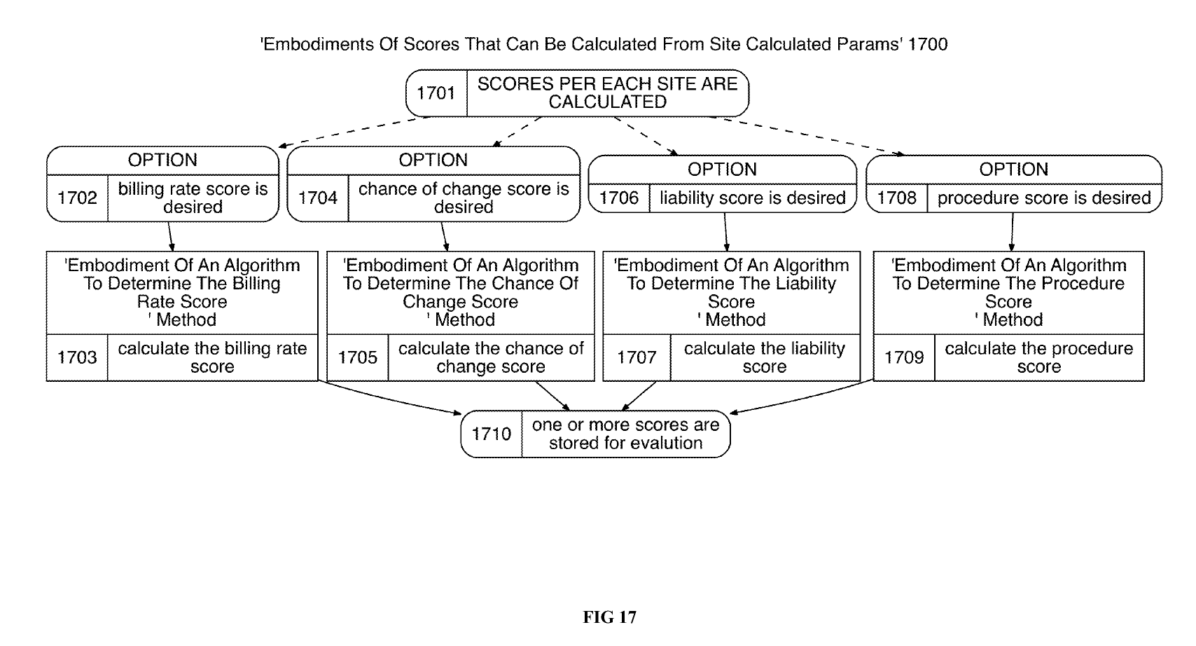

Now referring to FIG. 17, next, for one or more remote worker, site metadata object 1000 are aggregated and site calculated parameters 1103 are generated for one more by site calculator 1102 (Step 1701). This is further detailed below in (Step 1801-Step 1826).

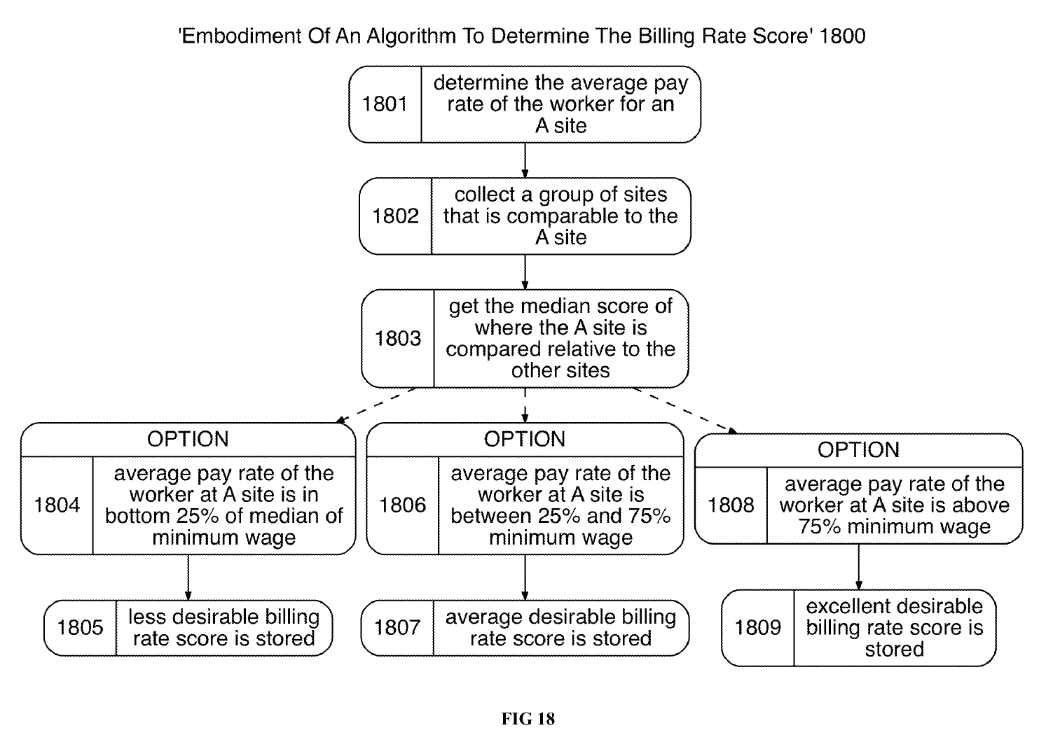

Now referring to FIG. 18, next, one or more site metadata objects is evaluated (Step 1801). If length of time a remote worker manager is engaged with a security site data is to be calculated (Step 1802), then, calculate from temporal metadata object 900, the min and max, and start and end times for the aggregation of remote worker data (Step 1803).

If number of contractors data is to be calculated (Step 1804), then, for each remote worker manager, count how many contractors there are for a particular site (Step 1805) and then one or more site calculated parameters 1103 are stored (Step 1826). If number of contractors data is to be calculated (Step 1804) and if the duration of each contractor data is to be calculated (Step 1806). Then, one may access the aggregated remote workers at that site for that time period and look at min and max start dates to get the value (Step 1807) and then proceed to Step 1826.

If shift organization data is to be calculated (Step 1808), then, one may examine temporal metadata object 900 from each remote worker in order to get a basic overview (Step 1809). Then, examine from shift metadata object 902, the days of week and hours (Step 1810). Then, create an estimated composite average of typical weekly shifts (billable hours) (Step 1811). Then proceed to Step 1826 where one or more site calculated parameters 1103 are stored (Step 1826).

If billable hours data is to be calculated (Step 1812), then, examine from financial metadata object 1001 for what remote worker was paid (Step 1813). Then, examine from temporal metadata object 900 the hours worked (Step 1814). Then, generate estimated billing rate (Step 1815). Then, generate an estimated total billable hours per week (Step 1816). Then proceed to Step 1826 where one or more site calculated parameters 1103 are stored (Step 1826).

If current billing rate is to be calculated (Step 1817). Then, examine from financial metadata object 1001 for what the latest billing rate is for one or more remote worker (Step 1818). Then proceed to Step 1826 where one or more site calculated parameters 1103 are stored (Step 1826).

If service type data is to be calculated (Step 1819), then, aggregate service type metadata object for all the remote workers for the site (Step 1820). Then, filter by unique data instances (Step 1821). Then proceed to Step 1826 where one or more site calculated parameters 1103 are stored (Step 1826).

If contact name data is to be calculated (Step 1822), then, aggregate one or more remote worker and then get the business metadata object and get the highest frequency contact name and/or latest appearing contact name (depending on temporal circumstances) (Step 1823).

If information confidence interval data is to be calculated (Step 1824), then, calculate the quantity of per site aggregated remote workers data relative to other sites (Step 1825). Next, one or more site calculated parameters 1103 are stored (Step 1826).

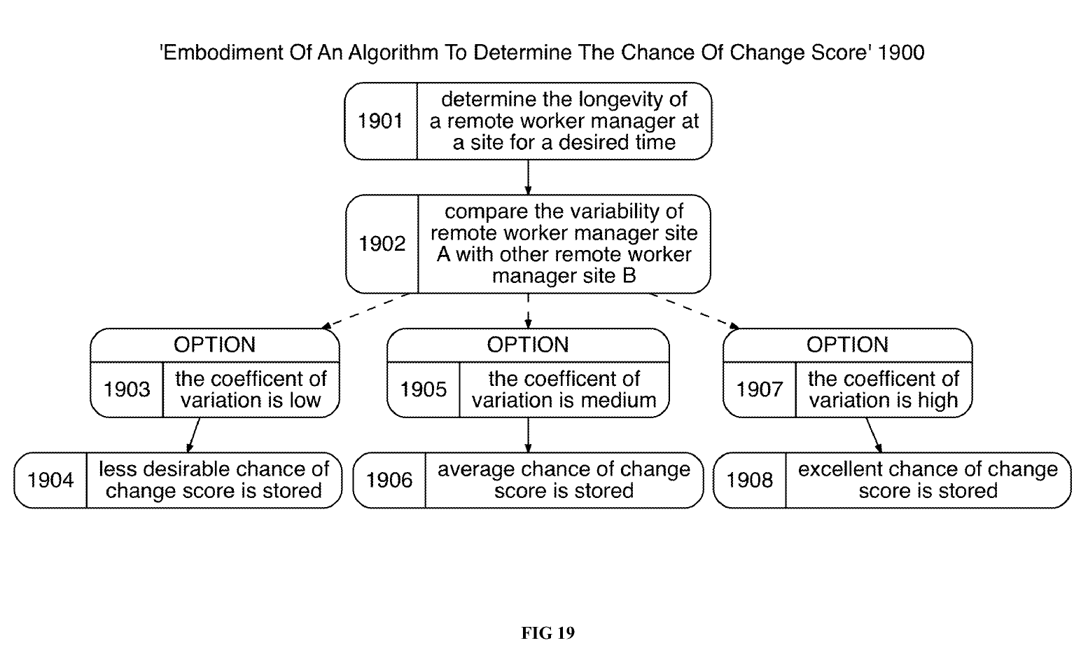

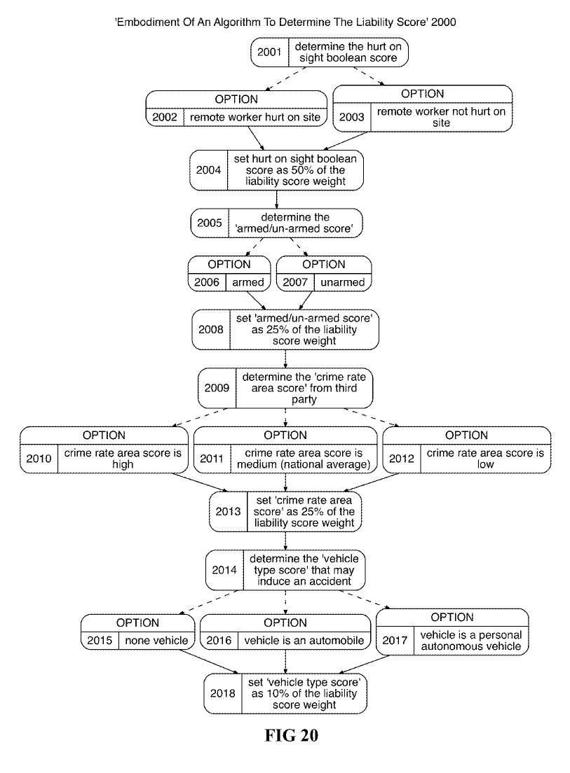

Referring back to FIG. 17, next, one or more site rating scores are generated from site calculated parameters 1103 (Step 1702). This is further detailed below in (Step 1901-Step 1910). Now referring to FIG. 19, next, scores for each site are calculated (Step 1901). If billing rate score is desired (Step 1902), then, calculate the billing rate score (Step 1903) as detailed in (Step 2001-Step 2003) below. Now referring to FIG. 20, next, determine the average ay rate of the worker for an A site (Step 2001). Next, collect a group of sites that is comparable to the A site (Step 2002). Next, get the median score of where the A site is compared relative to the other sites (Step 2003). If average pay rate of the worker at A site is in the bottom 25% of median of minimum wage (Step 2004), then, the less desirable billing rate score is stored (Step 2005). If average pay rate of the worker at A site is between 25% and 75% minimum wage (Step 2006), then, average desirable billing rate score is stored (Step 2007). If average pay rate of the worker at A site is above 75% minimum wage (Step 2008), then, excellent desirable billing rate score is stored (Step 2009).

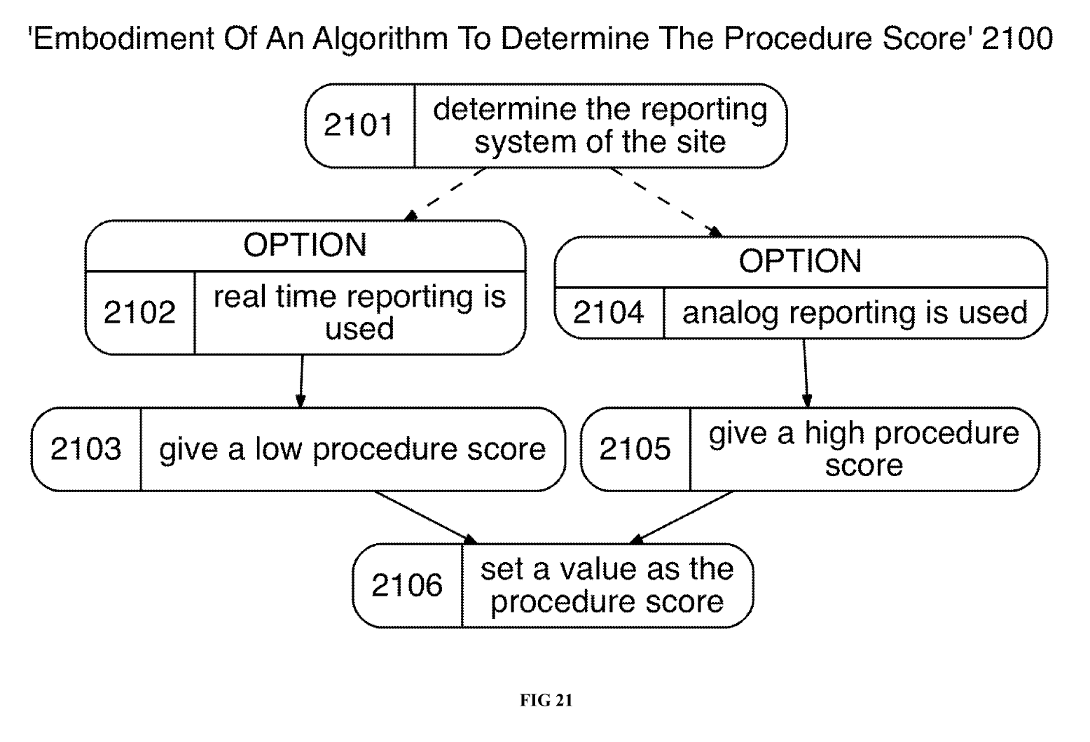

Referring back to FIG. 19, if chance of change score is desired (Step 1904), then, calculate the chance of change score (Step 1905). As detailed in (Step 2101-Step 2102) below. Now referring to FIG. 21, next, determine the longevity of a remote worker manager at a site for a desired time (Step 2101). Next, compare the variability of remote worker manager site A with other remote worker manager site B (Step 2102). If the coefficient of variation is low (Step 2103), then, less desirable chance of change score is stored (Step 2104). If the coefficient of variation is medium (Step 2105), then, average chance of change score is stored (Step 2106). If the coefficient of variation is high (Step 2107), then, excellent chance of change score is stored (Step 2108).

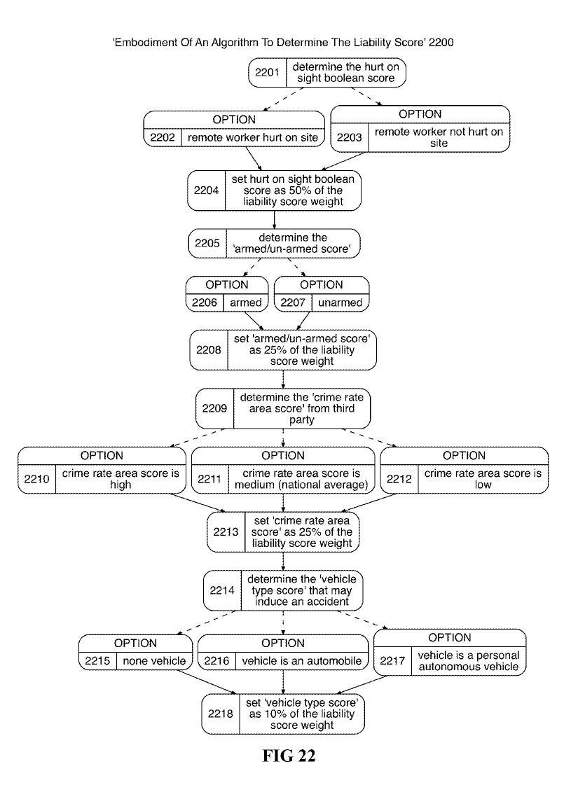

Referring back to FIG. 19, if liability score is desired (Step 1906), then, calculate the liability score (Step 1907), as detailed in (Step 2201-Step 2218) below. Now referring to FIG. 22, next, determine the hurt on sight boolean score (Step 2201). If remote worker hurt on site (Step 2202) then store this value and proceed to Step 2204. If remote worker not hurt on site (Step 2203) then store this value and proceed to Step 2204. Next, set hurt on sight boolean score as 50% of the liability score weight (Step 2204).

Next, determine the ‘armed/un-armed score’ (Step 2205). If armed (Step 2206) then store this value and proceed to Step 2208. If unarmed (Step 2207) then store this value and proceed to Step 2208. Next, set ‘armed/un-armed score’ as 25% of the liability score weight (Step 2208).

Next, determine the ‘crime rate area score’ from third party (Step 2209). If crime rate area score is high (Step 2210) then store this value and proceed to Step 2213. If crime rate area score is medium (national average) (Step 2211) then store this value and proceed to Step 2213. If crime rate area score is low (Step 2212) then store this value and proceed to Step 2213. Next, set ‘crime rate area score’ as 25% of the liability score weight (Step 2213).

Next, determine the ‘vehicle type score’ that may induce an accident (Step 2214). If no vehicle (Step 2215), then store this value and proceed to Step 2218. If vehicle is an automobile (Step 2216), then store this value and proceed to Step 2218. If vehicle is a personal autonomous vehicle (Step 2217) then store this value and proceed to Step 2218. Next, set ‘vehicle type score’ as 10% of the liability score weight (Step 2218).

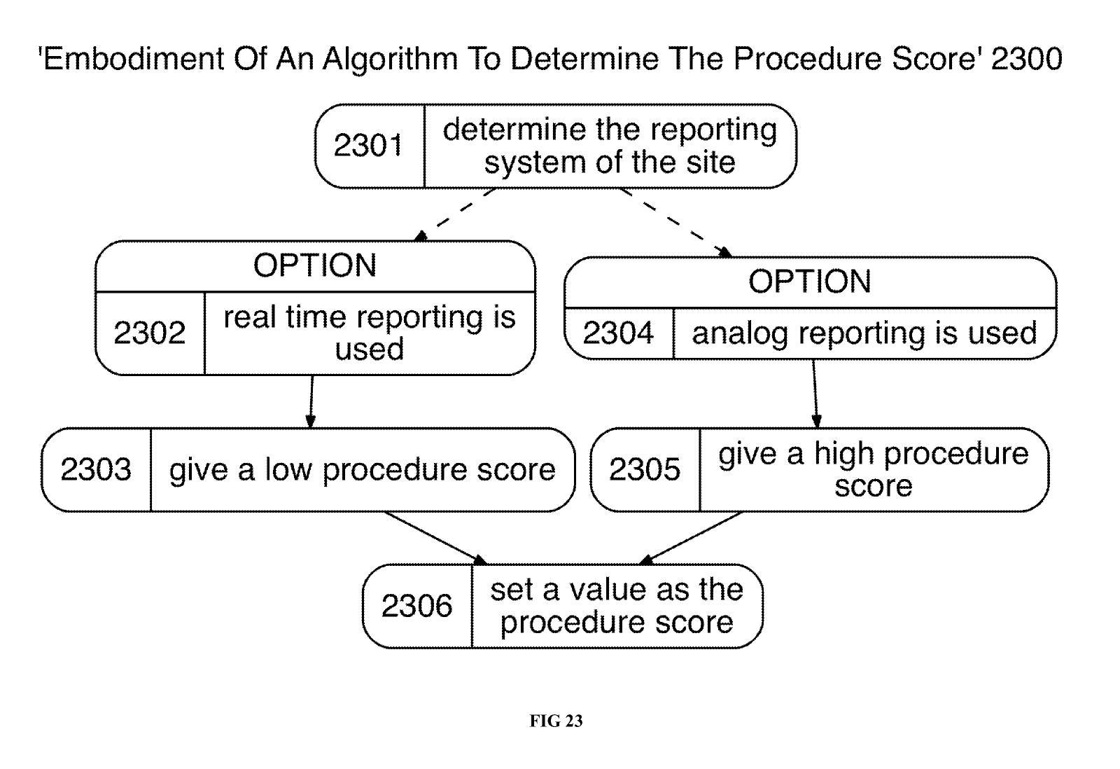

Referring back to FIG. 19, if procedure score is desired (Step 1908), then, calculate the procedure score (Step 1909), as detailed in (Step 2301-Step 2306) below. Now referring to FIG. 23, next, determine the reporting system of the site (Step 2301). If real time reporting is used (Step 2302), then give a low procedure score (Step 2303). If analog reporting is used (Step 2304), then give a high procedure score (Step 2305). Next, set a value as the procedure score (Step 2306).

Referring back to FIG. 19, then, one or more scores are stored for evaluation (Step 1910). Referring back to FIG. 13, on evaluation device 504, one or more remote worker manager evaluates site rating scores to determine the economic feasibility of that site for the remote worker manager services (Step 1303).

The invention has some elements that are commonly known and other terms defined as specific to this specification. These include: one or more computing device 100, one or more CPU 101, one or more processor 102, one or more local memory 103, one or more interface 104, one or more physical ports, one or more independent processor, one or more interface memory, one or more NIC, one or more busses, one or more memory 200, one or more non volatile memory 400, one or more storage devices 201, one or more input devices 202, one or more keyboard 401, one or more touchscreen, one or more microphone, mouse 402, touchpad, trackball, one or more input output units 403, one or more operating systems 203, one or more output devices 204, one or more real time clock 404, one or more power supply 405, one or more power source 406, one or more program instructions, distributed computing network 300, one or more client application 205, one or more client 301, one or more server 302, one or more external service 303, one or more shared services 206, one or more database 304, one or more security system 305, configuration system 306, one or more remote memory 105, one or more system server, one or more communications network 106, site, site manager, site service organizer, remote worker, general employment information, and finally remote worker manager. However their use and relationships to the novel components and steps of the invention render them applicable herein. In order to preface the roles they play in the specification, they are subsequently explained here.

In some embodiments, an example of an independent processor could be an audio processor or a video processor and the like. In some embodiments, a independent processor serves to allow communication with appropriate media. In some embodiments, an example of an interface memory may include volatile and/or non-volatile memory (e.g., RAM) and the like. NIC comprises a computer hardware component that connects a computer to a computer network.

Busses comprises a communication system that transfers data between components inside a computer, or between computers. Program instructions (block of which termed modules) comprises a mechanism for control execution of system, or comprise of an operating system, and/or one or more applications. In some embodiments, examples of program instructions may include: an object code, a code produced by a compiler, a machine code, a code produced by an assembler or a linker, a byte code, a code executed using an interpreter, or a code on local memo. In some embodiments, a program instructions serves to communicate with a plurality of other computing devices, such as clients or servers, over communications networks. In yet other embodiments, a program instructions may also serve to implement the system and/or methods of the present invention. In yet other embodiments, a program instructions may also serve to blocks of program instructions are modules, that may exist in different memory stores, or devices and perform comparable functions, though in different physical locations. Additionally, in other embodiments, the program instructions serves to program instructions (and modules that comprise them), that may exist on many types of memory 200, including but not limited to, non volatile memory 400, local memory 103, interface memory, or storage devices 201. A system server comprises computing device 100 that communicates with a plurality of other computing devices, such as clients or servers, over communications networks.

A site comprises an area or location in which a service needs to be performed. A site manager comprises one or more persons who is the decision maker with respect to the service contracts for services rendered on one or more specific sites. A site service organizer comprises the person who oversees the contract on behalf of the site executed by the site manager to preform services on a site.

A remote worker comprises one or more persons who perform services on a site. General employment information comprises data or data object that contains the general desired information from a remote worker manager in order to determine if a remote worker is matched to perform at a particular job. In some embodiments, examples of general employment information may include: a name, an address, an e-mail address, an address for website or online portfolio, phone numbers, an objective statement, a work history, a job title, an employer's name, an employer's city, an employer's state, start and end dates, an education, a degrees held, an institution location, an institution, a field of study, a memberships to organizations volunteer work, military experiences, computer skills, awards, or hobbies.

What is claimed is:

1. A market identification via applicant work history data comprising a remote applicant system (RAMS) wherein the RAMS further comprises:
a. A RAD (remote applicant device) wherein the RAD further comprises a remote applicant submitter;
b. An evaluation device; and
c. A remote applicant processor.

2. The apparatus of claim 1 wherein the remote applicant submitter further comprises:
a. A previous remote worker submitter wherein the previous remote worker submitter further comprises a site metadata submitter wherein the site metadata submitter further comprises:
i. A business metadata submitter;
ii. A property metadata submitter;
iii. A financial metadata submitter;
iv. A third-party metadata submitter;
v. A work verification metadata submitter; and
vi. A temporal metadata submitter.

3. The market identification system of claim 1 wherein the remote applicant processor further comprises:
a. A site metadata aggregator;
b. A remote worker manager configurator;
c. A site calculator;
d. A site calculated parameters;
e. A site evaluator;
f. An evaluation scores; and
g. A site metadata object.

4. The market identification system of claim 3 wherein the site metadata object further comprises:
a. Business metadata object;
b. Property metadata object;
c. Financial metadata object;
d. Third party metadata object;
e. Work verification metadata object; and
f. Temporal metadata object.

5. The market identification system of claim 4 wherein the business metadata object further comprises:
a. A longevity metadata object;
b. An equipment metadata object;
c. A site type metadata object; and
d. A contact metadata object.

6. The market identification system of claim 4 wherein the property metadata object further comprises:
a. A risk factor metadata object
b. An armed metadata object
c. A certification metadata object
d. A service type metadata object
e. A third party metadata object

7. The market identification system of claim 4 wherein the work verification metadata object further comprises:
a. A verifiable metadata object; and
b. A non-verifiable metadata object.

8. The market identification system of claim 4 wherein the temporal metadata object further comprises:
a. Employment duration metadata object; and
b. Shift metadata object.
